(19) United States
(12) Patent Application Publication
(10) Pub. No.: US 2023/0212030 A1
(43) Pub. Date: Jul. 6, 2023

(54) DEVICE AND METHOD FOR SELECTING OPTIMAL WATER TREATMENT MODEL FOR CHEMICAL DOSING OPTIMIZATION

(71) Applicant: DOOSAN ENERBILITY CO., LTD., Changwon-si (KR)

(72) Inventors: Sang Gun NA, Seoul (KR); Hyun Sik KIM, Gimpo (KR); Jun Woo YOO, Seoul (KR)

(21) Appl. No.: 18/068,036

(22) Filed: Dec. 19, 2022

(30) Foreign Application Priority Data
Jan. 6, 2022 (KR) 10-2022-0002171

(51) Int. Cl. C02F 1/00; G05B 13/02; C02F 9/00

(52) U.S. Cl. CPC C02F 1/008; G05B 13/0265; C02F 9/00; C02F 1/24

(57) ABSTRACT

A device for selecting an optimal model includes: a model storage part including a seed model storage place in which a seed model is stored, and an optimal model storage place in which an existing optimal model is stored; a model generation part configured to use training data to generate a variable model; and a model evaluation part configured to prepare evaluation data, and use the evaluation data to select a champion model from among a plurality of evaluation target models including the seed model, the existing optimal model, and the variable model by evaluating the plurality of evaluation target models.

### CROSS REFERENCE TO RELATED APPLICATION

The present application claims priority to Korean Patent Application No. 10-2022-0002171, filed Jan. 6, 2022, the entire contents of which are incorporated herein for all purposes by this reference.

### BACKGROUND OF THE INVENTION

### 1. Field of the Invention

The present disclosure relates to a technology for selecting an optimal water treatment model. More particularly, the present disclosure relates to a device and a method for selecting an optimal water treatment model for chemical dosing optimization.

### 2. Description of the Background Art

Pre-treatment performed by a seawater desalination plant uses chemicals, such as a pH control agent and a coagulant, at a stage before a dissolved air flotation (DAF) process in order to remove suspended materials such as solids. Existing methods rely on sampling experiments and operators' knowledge in order to dose appropriate chemicals, but it is difficult to perform control by applying real-time state changes in feed water, such as seawater, wastewater, etc.

The foregoing is intended merely to aid in the understanding of the background of the present disclosure, and is not intended to mean that the present disclosure falls within the purview of the related art that is already known to those skilled in the art.

### SUMMARY OF THE INVENTION

The present disclosure is directed to providing a device and a method for selecting an optimal water treatment model for chemical dosing optimization.

According to an exemplary embodiment of the present disclosure, there is provided a device for selecting an optimal model, the device including: a model storage part including a seed model storage place in which a seed model is stored, and an optimal model storage place in which an existing optimal model is stored; a model generation part configured to use training data to generate a variable model; and a model evaluation part configured to prepare evaluation data, and use the evaluation data to select a champion model from among a plurality of evaluation target models including the seed model, the existing optimal model, and the variable model by evaluating the plurality of evaluation target models.

The model evaluation part may be configured to receive the training data created from raw data received within a predetermined period of time from a time point of evaluation, detect input data and output data related to the input data from the received training data, set the output data as an expected value, and set the input data and the expected value as the evaluation data.

The model evaluation part may be configured to input the input data to each of the plurality of evaluation target models, and in response to performing operation on the input data by each of the plurality of evaluation target models to calculate a prediction value, calculate a difference between the expected value and the prediction value of each of the plurality of evaluation target models as an error of each of the plurality of evaluation target models, and select the evaluation target model having the smallest error among the plurality of evaluation target models as the champion model.

The device may further include a model management part that is configured to, in response to selecting the variable model as the champion model, store the variable model selected as the champion model as the optimal model in the optimal model storage place in a FIFO manner.

The device may further include a model management part that is configured to decide whether there is insufficiency of a storage space of the optimal model storage place, and the model management part is further configured to, in response to selecting the variable model as the champion model and deciding insufficiency of a storage space of the optimal model storage place, delete the existing optimal model in chronological order of storage according to a FIFO manner and store the variable model selected as the champion model as the optimal model in the optimal model storage place in a FIFO manner.

The device may further include a model management part that is configured to, in response to selecting the existing optimal model as the champion model, extract the existing optimal model selected as the champion model from the optimal model storage place and store the existing optimal model again in the optimal model storage place in a FIFO manner.

The device may further include a model management part that is configured to, in response to selecting the seed model as the champion model, maintain a state in which the seed model selected as the champion model is stored in the seed model storage place.

The model generation part may be configured to generate the variable model through training with the training data created from raw data collected within a predetermined period of time from a time point of generation, the variable model being based on design information of the seed model.

According to an exemplary embodiment of the present disclosure, there is provided a device for selecting an optimal model, the device including: a model evaluation part configured to, in response to generation of a variable model, use evaluation data to select a champion model from among a plurality of evaluation target models including the generated variable model, a seed model stored in a seed model storage place, and an existing optimal model stored in an optimal model storage place by evaluating the plurality of evaluation target models; and a model management part configured to store the champion model in the optimal model storage place.

The model evaluation part may be configured to receive training data created from raw data received within a predetermined period of time from a time point of evaluation, detect input data and output data related to the input data from the received training data, set the output data as an expected value, and set the input data and the expected value as the evaluation data.

The model evaluation part may be configured to input the input data to each of the plurality of evaluation target models, and in response to performing operation on the input data by each of the plurality of evaluation target models to calculate a prediction value, calculate a difference between the expected value and the prediction value of each of the plurality of evaluation target models as an error of each of the plurality of evaluation target models, and select the evaluation target model having the smallest error among the plurality of evaluation target models as the champion model. The model management part may be configured to decide whether there is a insufficiency of a storage space of the optimal model storage place, and the model management part may be further configured to, in response to selecting the variable model as the champion model and deciding insufficiency of a storage space of the optimal model storage place, delete the existing optimal model in chronological order of storage according to a FIFO manner and store the variable model selected as the champion model as the optimal model in the optimal model storage place in a FIFO manner. The model management part may be configured to, in response to selecting the existing optimal model as the champion model, extract the existing optimal model selected as the champion model from the optimal model storage place and store the existing optimal model again in the optimal model storage place in a FIFO manner.

The device may further include a model generation part that is configured to generate the variable model through training with training data created from raw data collected within a predetermined period of time from a time point of generation, the variable model being based on design information of the seed model.

According to an exemplary embodiment of the present disclosure, there is provided a method for selecting an optimal model, the method including: maintaining a state in which a seed model is stored in a seed model storage place and an existing optimal model is stored in an optimal model storage place; using, by a model generation part, training data to generate a variable model; preparing evaluation data by a model evaluation part; and using, by the model evaluation part, the evaluation data to select a champion model from among a plurality of evaluation target models including the seed model, the existing optimal model, and the variable model by evaluating the plurality of evaluation target models.

The preparing of the evaluation data may include: receiving, by the model evaluation part, the training data created from raw data received within a predetermined period of time from a time point of evaluation; detecting, by the model evaluation part, input data and output data related to the input data from the received training data; setting, by the model evaluation part, the output data as an expected value; and setting, by the model evaluation part, the input data and the expected value as the evaluation data.

The selecting of the champion model may include: inputting, by the model evaluation part, the input data to each of the plurality of evaluation target models; performing, by each of the plurality of evaluation target models, operation on the input data to calculate a prediction value; calculating, by the model evaluation part, a difference between the expected value and the prediction value of each of the plurality of evaluation target models as an error of each of the plurality of evaluation target models; and selecting, by the model evaluation part, the evaluation target model having the smallest error among the plurality of evaluation target models as the champion model.

The method may further include storing, by a model management part in response to selecting the variable model as the champion model, the variable model selected as the champion model in the optimal model storage place in a FIFO manner.

The method may further include deciding whether there is an insufficiency of a storage space of the optimal model storage place, in response to selecting the variable model as the champion model and deciding insufficiency of a storage space of the optimal model storage place, deleting, by a model management part, the existing optimal model in chronological order of storage according to a FIFO manner and storing the variable model selected as the champion model in the optimal model storage place in a FIFO manner.

The method may further include extracting, by a model management part in response to selecting the existing optimal model as the champion model, the existing optimal model selected as the champion model from the optimal model storage place and storing the existing optimal model again in the optimal model storage place in a FIFO manner.

The method may further include maintaining, by a model management part in response to selecting the seed model as the champion model, the state in which the seed model selected as the champion model is stored in the seed model storage place.

In the generating of the variable model, the model generation part may generate the variable model through training with the training data created from raw data collected within a predetermined period of time from a time point of generation, the variable model being based on design information of the seed model.

According to the present disclosure, each time a variable model that is a new water treatment model is generated, a champion model is selected through evaluation, and chemical dosing optimization is performed with the champion mode as an optimal model, thereby adaptively coping with changes in an environment of a water treatment plant.

### BRIEF DESCRIPTION OF THE DRAWINGS

FIG. 1 is a diagram illustrating a configuration of a water treatment system according to an embodiment of the present disclosure.

FIG. 2 is a block diagram illustrating a configuration of a chemical dosing optimization apparatus according to an embodiment of the present disclosure.

FIGS. 3, 4, and 5 are block diagrams illustrating a detailed configuration of a device for generating a water treatment model for chemical dosing optimization.

FIG. 6 is a diagram illustrating a configuration of a device for selecting an optimal water treatment model for chemical dosing optimization according to an embodiment of the present disclosure.

FIGS. 7A to 7C are diagrams a storage structure of an optimal water treatment model for chemical dosing optimization according to an embodiment of the present disclosure.

FIG. 8 is a flowchart illustrating a chemical dosing optimization method for a water treatment plant according to an embodiment of the present disclosure.

FIG. 9 is a flowchart illustrating a chemical dosing optimization method for a water treatment plant according to an additional embodiment of the present disclosure.

FIG. 10 is a flowchart illustrating a method for generating a water treatment model for chemical dosing optimization.

FIG. 11 is a flowchart illustrating a method for selecting an optimal water treatment model for chemical dosing optimization according to an embodiment of the present disclosure.

FIG. 12 is a flowchart illustrating a method of selecting a champion model according to an embodiment of the present disclosure.

FIG. 13 is a diagram illustrating a computing device according to an embodiment of the present disclosure.

### DETAILED DESCRIPTION OF THE INVENTION

The present disclosure may be modified in various ways and has various embodiments, so particular embodiments of the present disclosure will be illustrated and described in detail. However, the present disclosure is not limited thereto, and the exemplary embodiments can be construed as including all modifications, equivalents, or substitutes in a technical concept and a technical scope of the present disclosure.

Also, “a module,” “a unit,” or “a part” in the disclosure performs at least one function or operation, and these elements may be implemented as hardware, such as a processor or integrated circuit, software that is executed by a processor, or a combination thereof. Further, a plurality of “modules,” a plurality of “units,” or a plurality of “parts” may be integrated into at least one module or chip and may be implemented as at least one processor except for “modules,” “units” or “parts” that should be implemented in a specific hardware.

The terms used in the present disclosure are merely used to describe the particular embodiments, and are not intended to limit the present disclosure. As used herein, the singular forms “a”, “an”, and “the” are intended to include the plural forms as well, unless the context clearly indicates otherwise. In the present disclosure, it is to be understood that terms such as “including”, “having”, “comprising” etc. are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

Hereinafter, exemplary embodiments of the present disclosure will be described in detail with reference to the drawings. Herein, it is noted that the same elements in the drawings are denoted by the same reference numerals. In addition, well-known functions and constructions that may obscure the gist of the present disclosure will not be described. For the same reason, some elements are exaggerated or omitted, or schematically shown in the drawings.

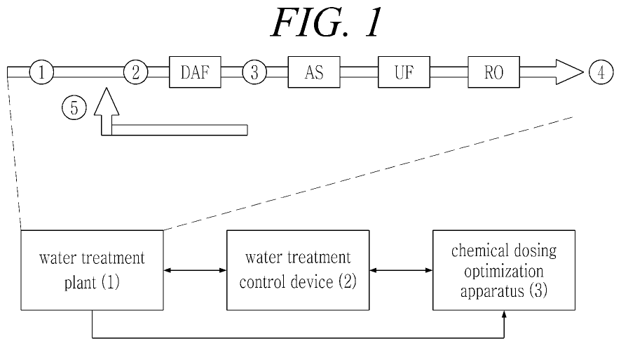

First, a water treatment system according to an embodiment of the present disclosure will be described. FIG. 1 is a diagram illustrating a configuration of a water treatment system according to an embodiment of the present disclosure. Referring to FIG. 1, the water treatment system according to an embodiment of the present disclosure includes a water treatment plant 1, a water treatment control device 2, and a chemical dosing optimization apparatus 3.

The water treatment plant 1 is for water treatment of treating feed water \textcircled{1} flowing into the water treatment plant 1 to suit an objective, and of discharging treated water \textcircled{4}. Examples of the water treatment include water treatment for a particular use, wastewater treatment, seawater desalination treatment, etc. The water treatment plant 1, according to an embodiment, includes a dissolved air flotation (DAF) device, an automatic strainer (AS), an ultrafiltration (UF) device, and a reverse osmosis (RO) device.

The DAF device treats the feed water \textcircled{2} according to dissolved air flotation. The automatic strainer (AS) removes solids remaining in the feed water \textcircled{3} treated by the DAF device so as to prevent foreign substances from flowing in. The UF device includes a plurality of ultrafiltration units each having an ultrafiltration membrane. The UF device performs an ultrafiltration process in which the ultrafiltration membranes of the plurality of ultrafiltration units are used to filter out impurities remaining in the feed water \textcircled{3}. The UF device may pass treated water through the ultrafiltration membranes of the plurality of ultrafiltration units so as to filter out impurities remaining in the treated water. The RO device includes a plurality of trains each having a reverse osmosis membrane. The RO device performs a reverse osmosis process in which the reverse osmosis membranes of the plurality of trains are used to filter out impurities remaining in the feed water \textcircled{3}. The RO device passes the treated water through the reverse osmosis membranes of the plurality of trains to filter out impurities remaining in the feed water \textcircled{3} according to a reverse osmosis principle, and discharges the treated water \textcircled{4}.

The water treatment control device 2 is basically a device for controlling the water treatment plant 1. In particular, chemicals are fed \textcircled{5} in an early-stage process of the water treatment plant 1, and the water treatment control device 2 may control the chemical dosage. More specifically, in the early-stage process of the water treatment plant 1, chemicals, for example, an ion concentration (pH) control agent (e.g., H2SO4) and a coagulant (e.g., FeCl3) are fed. The water treatment control device 2 may control the dosing and the dosage of the chemicals.

The chemical dosing optimization apparatus 3 is for chemical dosing optimization. As described above, the water treatment control device 2 controls chemical dosing and the dosage for the water treatment plant 1. Herein, chemical dosing optimization is required so that the state of the treated water by water treatment is maintained in a normal range and a minimum of the chemical dosage is used in the feed water as necessary. However, the chemical dosage affects the differential pressure (DP) of the automatic strainer (AS), the UF device, and the RO device performing a late-stage process, so chemical dosing optimization is performed considering the differential pressure. The chemical dosing optimization apparatus 3 is for performing such chemical dosing optimization by controlling the water treatment control device 2 or giving guidance thereto. The chemical dosing optimization apparatus 3 may perform the chemical dosing optimization by providing guidance information to the water treatment control device 2.

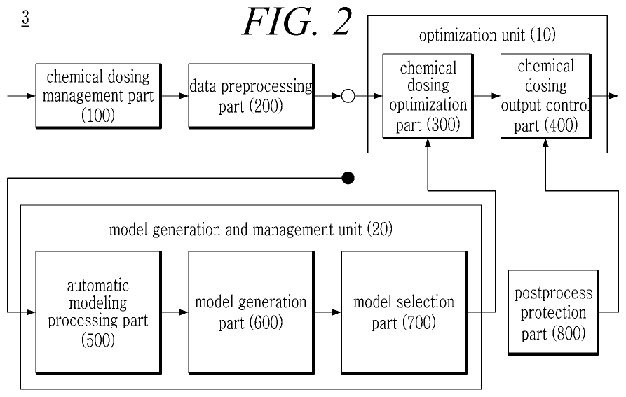

Next, a configuration of the chemical dosing optimization apparatus 3 according to an embodiment of the present disclosure will be described. FIG. 2 is a block diagram illustrating the configuration of the chemical dosing optimization apparatus according to an embodiment of the present disclosure. Referring to FIG. 2, the chemical dosing optimization apparatus 3 according to the embodiment of the present disclosure may include a chemical dosing management part 100 (performing DAF chemical dosing management), a data preprocessing part 200 (performing data preprocessing), an optimization unit 10 (performing chemical dosing optimization), a model generation and management unit 20 (performing DAF model generation and management), and a postprocess protection part 800 (performing postprocess protection logic). Furthermore, the optimization unit 10 may include a chemical dosing optimization part 300 (performing chemical dosing optimization algorithm) and a chemical dosing output control part 400 (which may be alternatively referred to as chemical dosing output controller). Furthermore, the model generation and management unit 20 may include an automatic modeling processing part 500 (which may be alternatively referred to as auto modeling processor for DAF model), a model generation part 600 (which may be alternatively referred to as DAF model candidate generator), and a model selection part 700 (which may be alternatively referred to as DAF model selection & management processor).

The chemical dosing management part 100 is for managing a chemical dosing optimization process. The chemical dosing management part 100 receives real-time data including operating data and state data from the water treatment plant 1 or the water treatment control device 2 or both, and analyzes the real-time data to determine whether to perform the chemical dosing optimization process. The real-time data means the operating data and the state data measured or derived in real time. In an embodiment of the present disclosure, the operating data may refer to and may include any one of all types of data including values, specifically, a set value (SV or target value (set point (SP))), a measured value (process variable (PV) or current value (CV)), and a manipulation value (manipulate variable (MV)), wherein the values are input to control processes or measured for the processes performed by the DAF device, the automatic strainer (AS), the UF device, and the RO device.

Herein, the set value (SV or SP) means a value for setting a control target of an object to be controlled. The measured value (PV or CV) means a sensed value obtained by measuring the object to be controlled. The manipulation value (MV) means a control value for manipulation so that the object to be controlled reaches the set value from the measured value. Examples of the set value and the measured value include flow rate, pressure, water level, temperature, etc. Examples of the manipulation value include an opening ratio, the RPM speed of a motor, voltage, current, etc. The operating data may be processed according to each objective and may be used for analysis.

In an embodiment of the present disclosure, data derived or processed for analyzing the operating data is referred to as the state data. Examples of the state data include values obtained by processing, through a logic derived through operating knowledge, data resulting from measuring a differential pressure of input and output stages of the UF device and the RO device.

The data preprocessing part 200 receives raw data. Herein, the raw data includes the operating data and the state data received by the data preprocessing part 200 from the water treatment plant 1 or the water treatment control device 2 or both. The raw data results from accumulation and storage of the operating data and the state data collected from the water treatment plant 1 and the water treatment control device 2. Accordingly, the raw data may include the real-time data including the operating data and the state data collected in real time. In addition, the raw data may include a plurality of types of data having different attributes. The raw data may be continuously received over time from the water treatment plant 1 or the water treatment control device 2. In particular, the raw data received by the data preprocessing part 200 may include input attribute data having input attributes and output attribute data having output attributes. The input attributes and the output attributes may be input attributes and output attributes of the water treatment plant 1.

The input attribute data may include the operating data and the state data related to the feed water flowing into the water treatment plant 1, in particular, the DAF device. Examples of the input attribute data may include the flow rate of the feed water, temperature, conductivity, acidity (or hydrogen ion concentration), turbidity, the throughput for the feed water (per unit time), the chemical dosage for the feed water, the chemical dosing concentration, etc. The output attribute data may include the operating data and the state data related to the treated water subjected to water treatment by the DAF device. Examples of the output attribute data may include acidity (or hydrogen ion concentration, pH) or a variation in acidity of the treated water, turbidity or a variation in turbidity, residual iron, etc. in the treated water.

According to an embodiment, when the raw data is collected, the data preprocessing part 200 preprocesses the raw data to generate training data. The training data may include data for training and data for verification divided according to use. In addition, the training data may include input data and output data divided according to attributes. The training data is provided to the model generation and management unit 20. In addition, the data preprocessing part 200 may preprocess the real-time data and may provide the preprocessed real-time data to the optimization unit 10. The data preprocessing part 200 may use tags indicating data attributes to perform preprocessing by analyzing the raw data including the real-time data. This preprocessing is to perform signal processing, normal data processing (based on knowledge/data), and outlier removal to remove noise, or to remove noise in data, or to remove data that may adversely affect generating a DAF model or designing a controller.

The optimization unit 10 analyzes the real-time data to derive a control value for optimizing the chemical dosage. The optimization unit 10 includes the chemical dosing optimization part 300 and the chemical dosing output control part 400 as described above.

According to an embodiment, the chemical dosing optimization part 300 may analyze current data, and uses an analysis result of the current data to select an optimum controller from among a plurality of controllers previously created, and searches for an optimal chemical dosing control value. To search for the optimal chemical dosing control value, optimization design information may be used. The optimization design information may include an objective function, a constraint, a moderator variable, a searching range, etc. Herein, using at least one water treatment model, the chemical dosing optimization part 300 may analyze the real-time data to derive a prediction value for predicting the state (for example, turbidity, pH, etc.) of the treated water of the water treatment plant 1. In addition, using at least one controller, the chemical dosing optimization part 300 may derive a control value based on the prediction value, such that the control value is to set a minimum of a chemical dosage to be dosed in the feed water, required for maintaining the state of the treated water of the water treatment plant 1 in the normal range. In other words, while the state of the treated water of the water treatment plant 1 is changed by an amount of chemical dosage used and the chemical dosage is changed by the control value, a control value may be derived by the chemical dosing optimization part 30 such that the control value is to set the lowest amount of the chemical dosage that makes the state of the treated water of the water plant 1 be in the normal range. The normal range of the treated water may be a predetermined value range of any indication of acidity (pH), turbidity, residual iron, dissolved oxygen, nitrogen, mercury, phosphorus, carbon dioxide, or hydrogen ion concentration of/in the treated water or any combination thereof.

The chemical dosing output control part 400 is basically for finally determining whether to provide or not provide the control value derived by the chemical dosing optimization part 300, according to a management command or a current state or both. The management command or the current state may be provided by the chemical dosing management part 100. The control value provided from the chemical dosing optimization part 300 to the chemical dosing output control part 400 is derived using the real-time data by the chemical dosing optimization part 300. However, there may be a case when the control value is data of the past the time, e.g., one minute or five minutes, ago than the present time point of processing by the chemical dosing output control part 40. In other words, there may be a case when it takes time for the chemical dosing optimization part 300 to search for the control value. Accordingly, according to an embodiment, the chemical dosing output control part 400 may compare the operating data and the state data that are the basis of calculation of the control value with the current operating data and the current state data. According to the comparison, when the differences are equal to or greater than reference values, the chemical dosing output control part 400 may correct the control value, or holds or stops the output of the control value. The chemical dosing output control part 400 may provide the control value according to the management command of the chemical dosing management part 100 such that the water treatment control device 2 applies the control value automatically, or may provide the control value in the form of guidance such that the water treatment control device 2 determines whether to apply the control value.

In addition, according to an embodiment, the chemical dosing output control part 400 may correct the control value by using a correction bias value derived by the postprocess protection part 800 according to a postprocess protection logic. In particular, the chemical dosing output control part 400 may convert the control value according to a control period and a control range of the water treatment control device 2 such that the water treatment control device 2 operates stably, and the chemical dosing output control part 400 provides the control value resulting from conversion to the water treatment control device 2. According to an embodiment of the present disclosure, the chemical dosing output control part 400 may divide the control value into application control values with a range applicable to the water treatment control device 2. That is, the chemical dosing output control part 400 calculates the application control values by dividing the control value according to the control period and the control range of the water treatment control device 2 compared to a period of derivation of the control value by the chemical dosing optimization part 300. For example, assuming that the time period, that is, the period of derivation of the control value, for the chemical dosing optimization part 300 to search for an optimal control value is one minute and the control period of the water treatment control device 2 is 10 seconds and the control range is ±4, the control value of which the period of derivation is one minute is divided considering the control period of 10 seconds of the water treatment control device 2 and the control range of ±4, thereby calculating the application control values. Specifically, when the control value is for increasing by 20 from an existing value, values, 4(+4), 8(+4), 12(+4), 16(+4), 20(+4), and 20(+0)), increased by 4 every 10 seconds are provided as the application control values.

The model generation and management unit 20 is for automatically generating at least one water treatment model through training. The water treatment model is an algorithm including at least one artificial neural network, and simulates the water treatment plant 1 that generates treated water through water treatment (for example, DAF) of feed water. According to an embodiment, the water treatment model may receive various types of information indicative of the state of the feed water, and calculates a prediction value for predicting the state of the treated water by performing an operation on the state of the feed water as trained. Herein, examples of the state of the feed water may include the flow rate of the feed water, temperature, conductivity, acidity (or hydrogen ion concentration), turbidity, the throughput for the feed water (per unit time), the chemical dosage for the feed water, the chemical dosing concentration, etc. In addition, examples of the state of the treated water may include acidity or a variation in acidity of the treated water, turbidity or a variation in turbidity, residual iron, etc.

According to an embodiment, the model generation and management unit 20 may include the automatic modeling processing part 500, the model generation part 600, and the model selection part 700.

The automatic modeling processing part 500 may design a water treatment model to be newly generated and generates model design information. The automatic modeling processing part 500 designs a form, a structure, input and output, and a variable of the water treatment model. According to an embodiment, the automatic modeling processing part 500 may receive and determine model design information, such as a form, a structure, input and output, and a variable, of a water treatment model. According to another embodiment, the automatic modeling processing part 500 may extract model design information from any one of a plurality of pre-stored seed models, and may design a water treatment model according to the extracted model design information. The seed models are models generated by experts among water treatment models. The automatic modeling processing part 500 extracts model design information including at least one selected from the group of a form, a structure, input and output, and a variable of a seed model, and applies the model design information to a water treatment model to be newly generated. The extracted model design information is applied to the water treatment model to be newly generated.

According to an embodiment, the model generation part 600 may receive the model design information from the automatic modeling processing part 500, and generates a water treatment model based on the model design information through training with the training data. That is, the model generation part 600 generates a plurality of water treatment models through training with the training data including the data for training and the data for verification, wherein the water treatment models simulate the water treatment plant and predict the states of the treated water according to the states of the feed water for the water treatment plant. The training data includes the data for training and the data for verification includes the input data and the output data corresponding to the input data. For example, examples of the input data may include the flow rate of the feed water, temperature, conductivity, acidity (or hydrogen ion concentration), turbidity, the throughput for the feed water (per unit time), the injection dosing concentration for the feed water, etc. In addition, examples of the output data may include acidity or a variation in acidity of the treated water, turbidity or a variation in turbidity, etc. Herein, in training, the output data may be used as a target value corresponding to the input data.

According to an embodiment, the model selection part 700 may select the optimal water treatment model by comparing a water treatment model generated by the model generation part 600 with pre-stored water treatment models for evaluation. To this end, evaluation data indicative of the water treatment plant 1 at the time point of evaluation may be used to evaluate the plurality of water treatment models. Similarly to the training data, the evaluation data may include input data and output data corresponding to the input data. That is, the model selection part 700 generates the evaluation data based on data collected from the water treatment plant 1 at the time point of evaluation, and performs evaluation with the generated evaluation data. That is, the model selection part 700 may use the evaluation data collected from the water treatment plant 1 at the time point of evaluation to evaluate the plurality of water treatment models. As an evaluation result, the model selection part 700 may select, among the plurality of water treatment models, the water treatment model having the highest similarity to the water treatment plant 1 at the time point of evaluation. Next, the model selection part 700 may provide the selected water treatment model to the chemical dosing optimization part 300. In addition, each time evaluation ends, the model selection part 700 may arrange the water treatment models in order of generation. When the storage capacity of a storage space in which the water treatment models are stored is insufficient, the model selection part 700 may delete, among the unselected water treatment models, the water treatment models sequentially in chronological order of generation.

According to an embodiment, the postprocess protection part 800 may receive postprocess data including the operating data and the state data of the late-stage process, specifically, the process performed by the automatic strainer (AS), the UF device, and the RO device, of the water treatment plant 1 and may analyze the received postprocess data to derive a correction bias value for protecting the postprocess according to a postprocess protection logic for preventing damage to the late-stage process, for example, a situation in which fouling occurs. Herein, fouling means a phenomenon in which contaminants in the feed water clog a membrane. The correction bias value may be provided to the chemical dosing output control part 400.

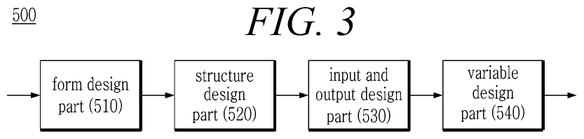

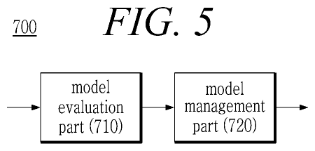

Next, a detailed configuration of a device for generating a water treatment model for chemical dosing optimization according to an embodiment of the present disclosure will be described. FIGS. 3, 4, and 5 are block diagrams illustrating the detailed configuration of a device for generating a water treatment model for chemical dosing optimization.

Referring to FIG. 3, the automatic modeling processing part 500 is for generating design information that includes a model form, a model structure, input and output of a model, and a variable of a model, and is for providing the generated design information to the model generation part 600. According to an embodiment, the automatic modeling processing part 500 may include a form design part 510, a structure design part 520, an input and output design part 530, and a variable design part 540.

The form design part 510 may set the model form of a water treatment model. Examples of the model form may include autoregressive exogenous (ARX), finite impulse response (FIR), neural network (NN), state space (SS), etc. According to an embodiment, when a controller for deriving an optimal chemical dosage is determined, the form design part 510 may set a model form suitable for the form of the determined controller. According to another embodiment, the form design part 510 may adopt the model form of any one of the plurality of pre-stored seed models as the model form of a water treatment model. Herein, the seed models are models generated by experts among water treatment models. According to another embodiment, the model form may be adopted according to a user input.

The structure design part 520 may select a model structure. The model structure refers to the number of submodels per output of a water treatment model. For example, a structure having one model with one input and one output may be set, or a structure in which one input is input to a first submodel and an output of the first submodel is input to a second submodel and an output of the second submodel is a final output may be set. According to an embodiment, the structure design part 520 may adopt the model structure of any one of the plurality of pre-stored seed models as the model structure of a water treatment model. According to another embodiment, the structure design part 520 may adopt a model structure according to a user input.

The input and output design part 530 may set input and output of a water treatment model. For example, examples of the input may include the flow rate of the feed water, temperature, conductivity, acidity (or hydrogen ion concentration), turbidity, the throughput for the feed water (per unit time), the injection dosing concentration for the feed water, etc. In addition, examples of the output may include acidity or a variation in acidity of the treated water, turbidity or a variation in turbidity, residual iron or a variation in residual iron, etc. According to an embodiment, the input and output design part 530 may adopt input and output applied to any one of the plurality of pre-stored seed models as input and output of a water treatment model similarly. According to another embodiment, the structure design part 520 may set input and output of a water treatment model according to a user input.

The variable design part 540 may set a variable of a water treatment model. The variable may be a variable that determines linearity, exponent, and delay time. According to an embodiment, the input and output design part 530 may adopt a variable applied to any one of the plurality of pre-stored seed models as a variable of a water treatment model. According to another embodiment, the structure design part 520 may set a variable of a water treatment model according to a user input.

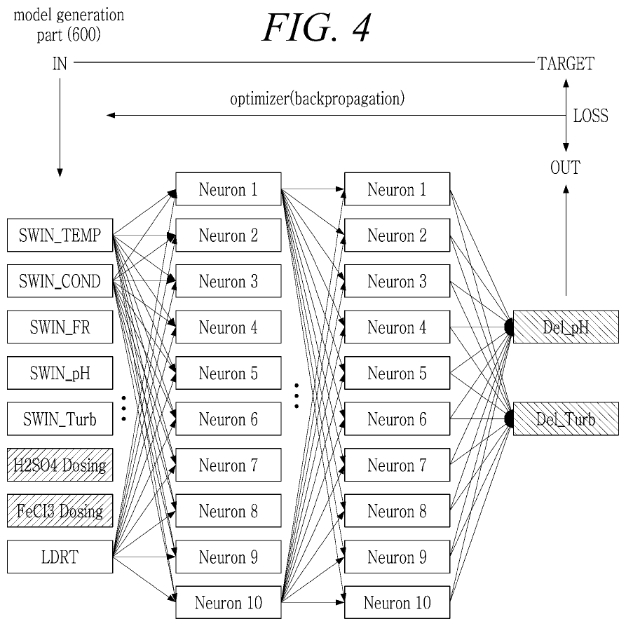

Referring to FIG. 4, the model generation part 600 is for training a water treatment model according to an embodiment of the present disclosure.

For example, according to the design information, it is assumed that a model form of the water treatment model is NN, and that a model structure has one input and one output, and that the inputs of the water treatment model include at least one of the flow rate of the feed water, temperature, conductivity, acidity (pH), turbidity, the throughput for the feed water (per unit time), and the chemical dosing concentration for the feed water, and that the outputs of the water treatment model include a variation in acidity and a variation in turbidity of the treated water.

The model generation part 600 may use the training data to train the water treatment model. The water treatment model used for training may be a seed model. Through such training, the model generation part 600 may thereby generate a water treatment model that simulates the water treatment plant 1 and predicts the state of the treated water according to the state of the feed water for the water treatment plant 1. The model generation part 600 may input the input data (IN), which corresponds to input, of the training data to the water treatment model. Based on the input date (IN), the water treatment model may calculate a prediction value (OUT). When the water treatment model calculates a prediction value (OUT) through operation, the model generation part 600 may calculate a loss that is a difference from the output data used as a target value through a loss function. The out data may be the prediction value (OUT). Then, the model generation part 600 may perform optimization in which parameters of the water treatment model are updated through, for example, a backpropagation algorithm so that the calculated loss is minimized. A water treatment model that is generated by the optimization process may be a variable model. Such optimization process in which parameters of the water treatment model are updated may be repeatedly performed. Through the repetition of such optimization, a water treatment model may be generated. The finally generated water treatment model that has the lowest calculated loss may be referred to as an optimized water treatment model.

The model selection part 700 may evaluate performances of water treatment models generated by the model generation part 600, may store a suitable water treatment model according to evaluation, and provide the water treatment model to the chemical dosing optimization part 300. The model selection part 700 may include a model evaluation part 710 and a model management part 720.

The model evaluation part 710 is for evaluating the performance of a water treatment model generated by the model generation part 600. The model evaluation part 710 may collect evaluation data, and uses the collected evaluation data to evaluate the performance of a water treatment model. The evaluation data may include input data and output data corresponding to the input data. The model evaluation part 710 may use the evaluation data collected from the water treatment plant 1 to select a water treatment model having the highest similarity to the water treatment plant among the generated water treatment models.

When the optimal water treatment model is selected according to an evaluation result of the model evaluation part 710, the model management part 720 may store the selected water treatment model in a predetermined storage space. The model management part 720 may arrange the water treatment models in order of generation. When the storage capacity of the storage space in which the water treatment models are stored is insufficient, the model management part 720 may delete, among the unselected water treatment models, the water treatment models sequentially in chronological order of generation. In other words, the model management part 720 may delete, from among the unselected water treatment models, the oldest water treatment model according to its chronological order of generation.

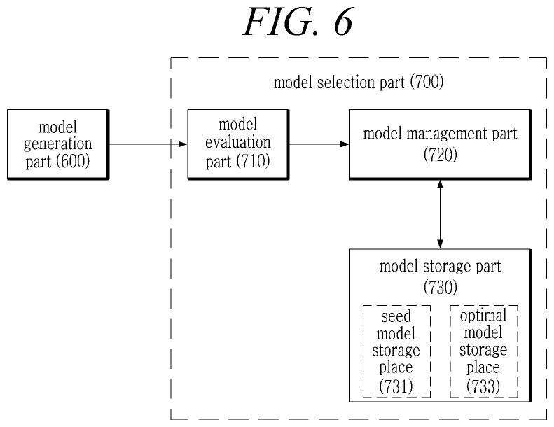

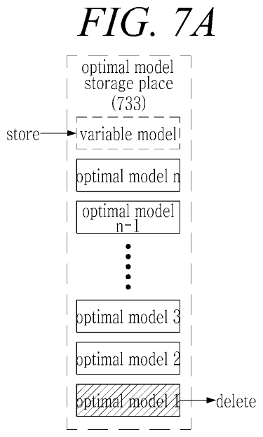

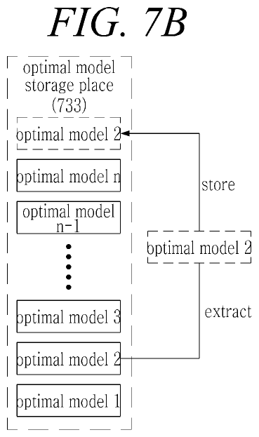

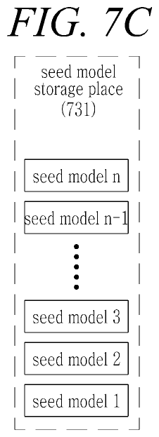

Next, a device for selecting an optimal water treatment model for chemical dosing optimization according to an embodiment of the present disclosure will be described. FIG. 6 is a diagram illustrating a configuration of the device for selecting an optimal water treatment model for chemical dosing optimization according to an embodiment of the present disclosure. FIGS. 7A to 7C are diagrams illustrating a storage structure of an optimal water treatment model for chemical dosing optimization according to an embodiment of the present disclosure.

Referring to FIG. 6, the device for selecting an optimal water treatment model for chemical dosing optimization according to an embodiment of the present disclosure includes the model generation part 600 and the model selection part 700, and the model selection part 700 includes the model evaluation part 710, the model management part 720, and a model storage part 730.

The model generation part 600 may generate a variable model based on design information of a seed model by using the training data. The generated variable model may be provided to the model evaluation part.

The model evaluation part 710 of the model selection part 700 uses the evaluation data to evaluate a plurality of evaluation target models including the generated variable model, seed models stored in a seed model storage place 731, and existing optimal models stored in an optimal model storage place 733, and then selects a champion model based on the evaluation. The selected model may be referred to as a champion model. The selected champion model may be provided to the optimization unit 10 and the model management part 720. The evaluation data may be generated using the training data extracted from the raw data received within a predetermined period of time from the time point of evaluation. The model evaluation part 710 may receive, from the data preprocessing part 200, the training data extracted from the raw data received within the predetermined period of time from the time point of evaluation, extract the input data of the received training data and the output data corresponding to the input data, and set the extracted output data as an expected value to prepare the evaluation data. The model evaluation part 710 may input the input data of the evaluation data to each of the plurality of evaluation target models including the seed models, the existing optimal models, and the variable model. Then, each of the plurality of evaluation target models calculates a prediction value by performing operation on the input data. Then, the model evaluation part 710 calculates a difference between the expected value and the prediction value of each of the plurality of evaluation target models as an error of each of the plurality of evaluation target models. Next, the model evaluation part 710 selects the evaluation target model having the smallest error among the plurality of evaluation target models as the champion model.

According to an embodiment, the model management part 720 is for storing and managing a water treatment model selected as the champion model. When the selected champion model is a variable model, the model management part 720 stores the variable model selected as the champion model in the optimal model storage place 733 in a FIFO manner (i.e, First-In-First-Out). Accordingly, the stored champion model may become an optimal model (i.e., an optimal water treatment model). Herein, when the storage space of the optimal model storage place 733 is insufficient, an existing optimal model stored in the optimal model storage place 733 may be deleted in chronological order of storage according to a FIFO manner and a new variable model selected as the champion model may be stored in the optimal model storage place 733 in a FIFO manner as shown in FIG. 7A. When the selected champion model is an existing optimal model, the model management part 720 may extract the existing optimal model selected as the champion model from the optimal model storage place 733 and stores the existing optimal model again in the optimal model storage place 733 in a FIFO manner as shown in FIG. 7B. By way of newly storing the existing optimal model selected as the champion model a FIFO manner, the champion model may be considered as a champion model recently stored one according to the FIFO chronological order. When the selected champion model is a seed model, the model management part 720 may maintain a state in which the seed model selected as the champion model is stored in the seed model storage place 731. Thus, as shown in FIG. 7C, there is no change.

According to an embodiment, the model storage part 730 is for storing water treatment models, and may include the seed model storage place 731 and the optimal model storage place 733. The seed models are water treatment models previously generated by experts and stored. The seed model storage place 731 is an area allocated for the seed models to be stored in the model storage part 730. Each time a champion model is selected, the champion model is stored in the optimal model storage place 733 and the champion model becomes an optimal model. The optimal model storage place 733 is an area allocated for the optimal model to be stored in the model storage part 730.

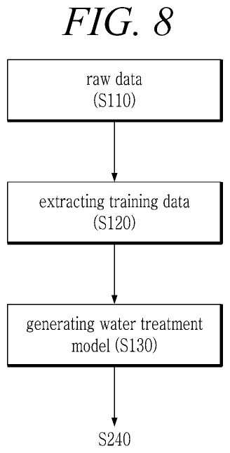

Next, a chemical dosing optimization method for a water treatment plant according to an embodiment of the present disclosure will be described. FIG. 8 is a flowchart illustrating the chemical dosing optimization method for a water treatment plant according to an embodiment of the present disclosure.

Referring to FIG. 8, a data preprocessing part 200 receives raw data in step S110. Herein, the raw data may include operating data and state data received from by the data preprocessing part 200 from a water treatment plant 1 or a water treatment control device 2 or both. The raw data results from accumulation and storage of the operating data and the state data collected over time from the water treatment plant 1 and the water treatment control device 2. Accordingly, the raw data may include real-time data including the operating data and the state data collected in real time. In particular, the raw data may include a plurality of types of data having different attributes. The raw data may be continuously received over time from the water treatment plant 1 or the water treatment control device 2. In particular, the raw data may include input attribute data having input attributes and output attribute data having output attributes. The input attribute data may include the operating data and the state data related to the feed water flowing into the water treatment plant 1, in particular, the DAF device. Examples of the input attribute data may include the flow rate of the feed water, temperature, conductivity, acidity (or hydrogen ion concentration), turbidity, the throughput for the feed water (per unit time), the chemical dosage for the feed water, the chemical dosing concentration, etc. The output attribute data may include the operating data and the state data related to the treated water treated by, for example, by the DAF device. Examples of the output attribute data may include acidity (or hydrogen ion concentration, pH) or a variation in acidity of the treated water, turbidity or a variation in turbidity, residual iron, etc.

When the raw data is collected, the data preprocessing part 200 preprocesses the raw data to generate training data in step S120. The training data includes data for training and data for verification divided according to use. In addition, the training data may include input data and output data divided according to attribute. The input data may be derived by preprocessing the input attribute data, and the output data may be derived by preprocessing the output attribute data. Examples of the input data may include the flow rate of the feed water, temperature, conductivity, acidity (or hydrogen ion concentration), turbidity, the throughput for the feed water (per unit time), the chemical dosage for the feed water, the chemical dosing concentration, etc. Examples of the output data may include acidity (or hydrogen ion concentration, pH) or a variation in acidity of the treated water, turbidity or a variation in turbidity, residual iron, etc.

Next, a model generation and management unit 20 including an automatic modeling processing part 500, a model generation part 600, and a model selection part 700 may receive the training data, and use the training data to generate a water treatment model in step S130. In step S130, the automatic modeling processing part 500 designs the water treatment model. The designing of the water treatment model means specifying the form of the model, the number of submodels belonging to one model, input, output, and a variable for the water treatment model. Then, the model generation part 600 uses the data for training of the training data to perform training on the designed water treatment model, thereby generating a water treatment model that simulates the water treatment plant 1 and predicts the state of the treated water according to the state of the feed water for the water treatment plant 1. Next, the model selection part 700 uses the data for verification of the training data to select, among a plurality of water treatment models. According to an embodiment, a water treatment model having the highest similarly to the water treatment plant 1 or having a lowest difference or error from the water treatment plant 1, from among the plurality of generated water treatment models, may be selected. The selected water treatment model may be provided to a chemical dosing optimization part 300 of an optimization unit 10.

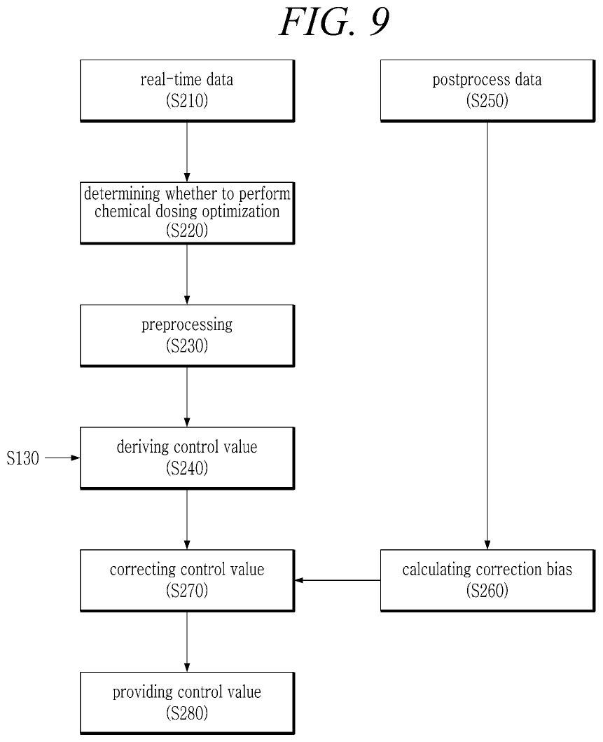

Next, a chemical dosing optimization method for a water treatment plant according to an additional embodiment of the present disclosure will be described. FIG. 9 is a flowchart illustrating the chemical dosing optimization method for a water treatment plant according to an additional embodiment of the present disclosure.

A chemical dosing management part 100 may receive real-time data including operating data and state data in step S210. Then, the chemical dosing management part 100 may analyze the real-time data to determine whether a water treatment plant 1 is abnormal, and determines whether to perform chemical dosing optimization for optimizing a chemical dosage in step S220. When the water treatment plant 1 is determined to be normal, then the chemical dosing management part 100 determines to perform chemical dosing optimization. When the chemical dosing management part 100 determines to perform chemical dosing optimization, then data preprocessing part 200 preprocesses the real-time data and provides the preprocessed real-time data to an optimization unit 10 including a chemical dosing optimization part 300 and a chemical dosing output control part 400 in step S230.

In the meantime, as described above with reference to FIG. 6, the optimization unit 10 may receive a water treatment model from a model generation and management unit 20. Accordingly, the chemical dosing optimization part 300 of the optimization unit 10 may analyze the real-time data through at least one water treatment model and at least one controller to derive a control value in step S240 according to the analysis, wherein the control value is for dosing a minimum of a chemical dosage while the state of the treated water of the water treatment plant is maintained in a normal range. Herein, the controller may be a search algorithm. Examples of the state of the treated water may include turbidity, acidity, residual iron, etc. In step S240, the at least one water treatment model analyzes the real-time data according to an input from the controller and derives a prediction value for predicting the state of the treated water of the water treatment plant, and the at least one controller searches for and derives a control value based on the prediction value of the water treatment model, wherein the control value is for dosing a minimum of a chemical dosage while the state of the treated water is maintained in the normal range. That is, a controller performs a simulation for predicting the state of the treated water of the water treatment plant through a water treatment model simulating the water treatment plant, thereby deriving an optimal control value.

In the meantime, the postprocess protection part 800 may receive postprocess data including the operating data and the state data of the late-stage process of the water treatment plant 1 in step S250. The late-stage process of the water treatment plant 1 may include at one of the process performed by the automatic strainer (AS), the UF device, and the RO device. The postprocess protection part 800 analyzes the received postprocess data to derive a correction bias value, and provides the correction bias value to the chemical dosing output control part 400 in step S260. The correction bias value is for protecting the postprocess according to a postprocess protection logic for preventing damage to the late-stage process in certain situation, for example, in which fouling occurs.

The chemical dosing output control part 400 may correct the control value according to the correction bias value and a control period and a control range of the water treatment control device 2 in step S270. Next, the chemical dosing output control part 400 may provide the control value derived by the chemical dosing optimization part 300 to the water treatment control device 2 according to a management command or a current state or both of the chemical dosing management part 100 in step S280. Herein, the chemical dosing output control part 400 may not provide the control value to the water treatment control device 2 according to the management command or the current state or both. In other words, chemical dosing output control part 400 may decide whether to provide the control value to the water treatment control device 2 according to the management command or the current state or both.

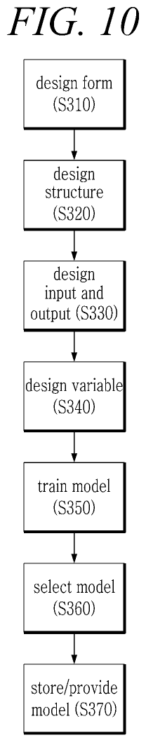

Next, a method for generating a water treatment model for chemical dosing optimization according to an embodiment of the present disclosure will be described. FIG. 10 is a flowchart illustrating the method for generating a water treatment model for chemical dosing optimization.

Referring to FIG. 10, a form design part 510 of an automatic modeling processing part 500 may set a model form of a water treatment model in step S310. Examples of the model form may include autoregressive exogenous (ARX), finite impulse response (FIR), neural network (NN), state space (SS), etc. According to an embodiment, when a controller for deriving an optimal chemical dosage is determined, the form design part 510 may set a model form suitable for the form of the determined controller. According to another embodiment, the form design part 510 may adopt the model form of any one of the plurality of pre-stored seed models as the model form of a water treatment model. Herein, the seed models are models generated by experts among water treatment models. According to another embodiment, the model form may be adopted according to a user input.

Next, a structure design part 520 of the automatic modeling processing part 500 may set a model structure in step S320. The model structure refers to the number of submodels per output of a water treatment model. For example, a model structure having one model with one input and one output may be set. For another example, a model structure in which one input is input to a first submodel and an output of the first submodel is input to a second submodel and an output of the second submodel is a final output may be set. According to an embodiment, the structure design part 520 may adopt the model structure of any one of the plurality of pre-stored seed models as the model structure of a water treatment model. According to another embodiment, the structure design part 520 may adopt a model structure according to a user input.

An input and output design part 530 of the automatic modeling processing part 500 may set input and output of a water treatment model in step S330. For example, examples of the input may include the flow rate of the feed water, temperature, conductivity, acidity (or hydrogen ion concentration), turbidity, the throughput for the feed water (per unit time), the injection dosing concentration for the feed water, etc. In addition, examples of the output may include acidity or a variation in acidity of the treated water, turbidity or a variation in turbidity, residual iron or a variation in residual iron, etc. According to an embodiment, the input and output design part 530 may adopt input and output applied to any one of the plurality of pre-stored seed models to be as similar as input and output of a water treatment model. According to another embodiment, the structure design part 520 may set input and output of a water treatment model according to a user input.

A variable design part 540 of the automatic modeling processing part 500 may set a variable of a water treatment model in step S340. The variable may be a variable that determines linearity, exponent, and delay time. According to an embodiment, the input and output design part 530 may adopt a variable applied to any one of the plurality of pre-stored seed models as a variable of a water treatment model. According to another embodiment, the structure design part 520 may set a variable of a water treatment model according to a user input.

In this way, through steps S310 to S340, design information including a model form, a model structure, input and output of a model, and a variable of a model may be generated, and the generated design information may be provided to a model generation part 600.

The model generation part 600 may use training data to train a water treatment model based on the design information in step S350, thereby generating a water treatment model that simulates a water treatment plant 1 and predicts the state of the treated water according to the state of feed water for the water treatment plant 1.

A model evaluation part 710 of a model selection part 700 may evaluate the performance of a water treatment model generated by the model generation part 600 in step S360. The model evaluation part 710 may collects evaluation data, and use the collected evaluation data to evaluate the performance of a water treatment model. The evaluation data may include input data and output data corresponding to the input data. The model evaluation part 710 may use the evaluation data collected from the water treatment device to select a water treatment model having the highest similarity to the water treatment plant 1 among the generated water treatment models.

When the optimal water treatment model is selected according to an evaluation result of the model evaluation part 710 in step S360, a model management part 720 of the model selection part 700 may store the selected water treatment model in a predetermined storage space and provides the selected water treatment model to a chemical dosing optimization unit 300 of an optimization unit 10. In storing the water treatment model, when the storage capacity of the storage space in which the water treatment models are stored is insufficient, the model management part 720 may delete, among the unselected water treatment models, the water treatment models sequentially in chronological order of generation or on the FIFO basis.

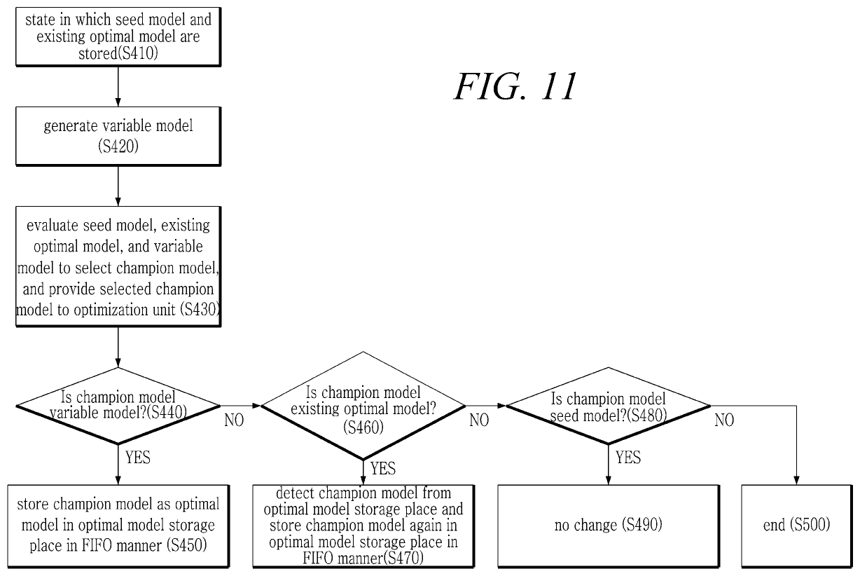

Next, a method for selecting an optimal water treatment model for chemical dosing optimization according to an embodiment of the present disclosure will be described. FIG. 11 is a flowchart illustrating the method for selecting an optimal water treatment model for chemical dosing optimization according to an embodiment of the present disclosure.

Referring to FIG. 11, it is assumed a state in which a model storage part 730 stores seed models in a seed model storage place 731 and stores existing optimal models in an optimal model storage place 733 in step S410. The seed models are water treatment models generated by experts and stored. The seed model storage place is an area allocated for the seed models to be stored in the model storage part 730. Each time an optimal model is selected, the optimal model may be stored in the optimal model storage place. The optimal model storage place is an area allocated for an optimal model to be stored in the model storage part 730.

A model generation part 600 may use training data to generate a variable model in step S420. The variable model is based on design information of a seed model, and is a water treatment model generated through training with training data created from raw data collected within a predetermined period of time from the time point of generation. When the variable model is generated, the generated variable model is stored in a model evaluation part 710.

The model evaluation part 710 may use evaluation data to evaluate a plurality of models. The models that are evaluated by the model evaluation part 710 may be referred to as target models. Target models includes the seed models stored in the seed model storage place 731, the existing optimal models stored in the optimal model storage place 733, and the variable model. By evaluation, the model evaluation part 710 may select a champion model in step S430 from among the seed model, the existing optimal models, and the variable models. The selected champion model may be provided to an optimization unit 10 and a model management part 720.

The model management part 720 may determine whether the selected champion model is a variable model in step S440. As a determination result in step S440, when the selected champion model is determined to be a variable model, the model management part 720 stores the variable model selected as the champion model in the optimal model storage place 733 in a FIFO manner in step S450. In step S450, when the storage space of the optimal model storage place 733 is insufficient, an existing optimal model stored in the optimal model storage place 733 may be deleted in chronological order of storage according to a FIFO manner and the variable model selected as the champion model may be stored as an optimal model in the optimal model storage place 733 in a FIFO manner as shown in FIG. 7A.

However, as the determination result in step S440, when the selected champion model is determined to be not a variable model, the model management part 720 determines whether the selected champion model is an existing optimal model in step S460.

As a determination result in step S460, when the selected champion model is determined to be an existing optimal model, the model management part 720 extracts the existing optimal model selected as the champion model from the optimal model storage place 733 and stores the existing optimal model again in the optimal model storage place in a FIFO manner as shown in FIG. 7B. By this way, the existing optimal model selected as the champion may be newly stored in the optimal model storage place in terms of the chronological order.

However, as the determination result in step S460, when the selected champion model is determined to be not an existing optimal model, the model management part 720 determines whether the selected champion model is a seed model in step S480.

As a determination result in step S480, when the selected champion model is determined to be a seed model, the model management part 720 maintains a state as it is in which the seed model selected as the champion model is stored in the seed model storage place in step S490. However, as the determination result in step S480, when the selected champion model is not a seed model, the process is terminated.

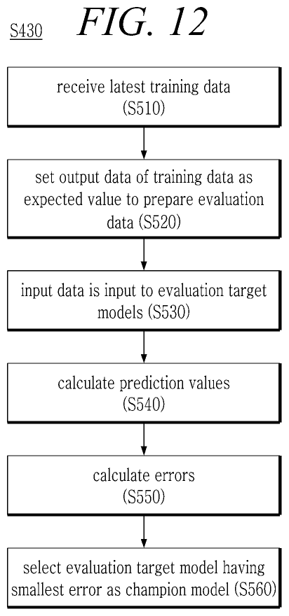

Then, a method of selecting a champion model in step S430 described above will be described in more detail. FIG. 12 is a flowchart illustrating the method of selecting a champion model according to an embodiment of the present disclosure. To emphasize, FIG. 12 is for a detailed description of step S430.

Referring to FIG. 12, the model evaluation part 710 may use, as the evaluation data, the training data generated by a data preprocessing part 200 from the latest raw data received within a predetermined period of time from the time point of evaluation. More specifically, the model evaluation part 710 may receive, from the data preprocessing part 200, the training data generated from the raw data received within the predetermined period of time from the time point of evaluation in step S510. Then, the model evaluation part 710 may extract input data of the received training data and output data corresponding to the input data, and sets the extracted output data as an expected value to prepare the evaluation data in step S520.

Next, the model evaluation part 710 may input the input data to each of the plurality of evaluation target models including the seed models, the existing optimal models, and the variable model in step S530. Then, each of the plurality of evaluation target models calculates a prediction value by performing operation of each of the plurality of evaluation target models based on the input data in step S540.

Next, the model evaluation part 710 may calculates a difference between the expected value and the prediction value of each of the plurality of evaluation target models as an error of each of the plurality of evaluation target models in step S550. Then, the model evaluation part 710 may select the evaluation target model having the smallest error among the plurality of evaluation target models as the champion model in step S560. In other words, from among the seed models, the variable model, the existing optimal models, and a model having the smallest error is selected as the champion model.

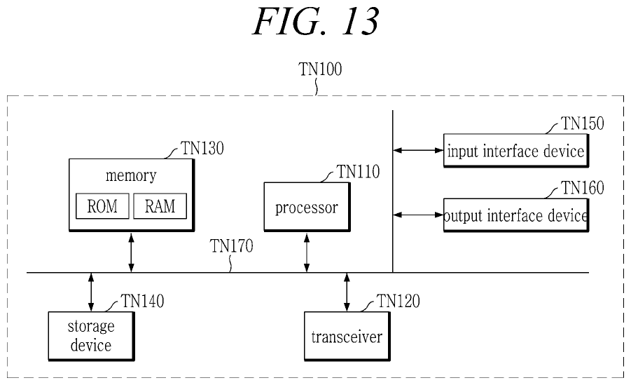

FIG. 13 is a diagram illustrating a computing device according to an embodiment of the present disclosure. A computing device TN100 may be the device or apparatus (for example, the water treatment control device 2 and the chemical dosing optimization apparatus 3) described in the present specification.

In the embodiment of FIG. 13, the computing device TN100 may include at least one processor TN110, a transceiver TN120, and a memory TN130. Furthermore, the computing device TN100 may include a storage device TN140, an input interface device TN150, and an output interface device TN160. The elements included in the computing device TN100 may be connected to each other via a bus TN170 to communicate with each other.

The processor TN110 may execute program commands stored in either the memory TN130 or the storage device TN140 or both. The processor TN110 may mean a central processing unit (CPU), a graphics processing unit (GPU), or a dedicated processor for performing the methods according to the embodiments of the present disclosure. The processor TN110 may be configured to realize the described procedures, functions, and methods related to the embodiments of the present disclosure. The processor TN110 may control each element of the computing device TN100.

Each of the memory TN130 and the storage device TN140 may store therein various types of information related to the operation of the processor TN110. Each of the memory TN130 and the storage device TN140 may be provided as either a volatile storage medium or a non-volatile storage medium or both. For example, the memory TN130 may be either a read only memory (ROM) or a random access memory (RAM) or both.

The transceiver TN120 may transmit or receive wired signals or wireless signals. The transceiver TN120 may be connected to a network to perform communication.

In the meantime, the various methods according to the above-described embodiments of the present disclosure may be implemented in the form of programs readable through various computer means and recorded on a computer-readable recording medium. Herein, the recording medium may include program commands, data files, data structures, and the like separately or in combinations. The program commands to be recorded on the recording medium may be specially designed and configured for embodiments of the present disclosure or may be well-known to and be usable by those skilled in the art of computer software. Examples of the recording medium include magnetic recording media such as hard disks, floppy disks and magnetic tapes; optical data storage media such as CD-ROMs or DVD-ROMs; magneto-optical media such as floptical disks; and hardware devices, such as read-only memory (ROM), random-access memory (RAM), and flash memory, which are particularly structured to store and implement the program instruction. Examples of the program instructions include not only a mechanical language formatted by a compiler but also a high level language that may be implemented by a computer using an interpreter, and the like. The hardware devices may be configured to be operated by one or more software modules or vice versa to conduct the operation according to the present disclosure.

Although the embodiments of the present disclosure have been described, those skilled in the art will appreciate that addition, change, or deletion of elements may modify and change the present disclosure in various ways without departing from the spirit and scope of the present disclosure disclosed in the claims, and such modifications and changes also fall within the scope of the present disclosure.

1. A device for selecting an optimal model, the device comprising:
a model storage part comprising a seed model storage place in which a seed model is stored, and an optimal model storage place in which an existing optimal model is stored;
a model generation part configured to use training data to generate a variable model; and
a model evaluation part configured to prepare evaluation data, and use the evaluation data to select a champion model from among a plurality of evaluation target models including the seed model, the existing optimal model, and the variable model by evaluating the plurality of evaluation target models.

2. The device of claim 1, wherein the model evaluation part is configured to
receive the training data created from raw data received within a predetermined period of time from a time point of evaluation,
detect, from the received training data, input data and output data related to the input data,
set the output data as an expected value, and
set the input data and the expected value as the evaluation data.

3. The device of claim 2, wherein the model evaluation part is configured to
input the input data to each of the plurality of evaluation target models, and
in response to performing operation on the input data by each of the plurality of evaluation target models to calculate a prediction value,
calculate a difference between the expected value and the prediction value of each of the plurality of evaluation target models as an error of each of the plurality of evaluation target models, and
select the evaluation target model having the smallest error among the plurality of evaluation target models as the champion model.

4. The device of claim 1, further comprising
a model management part configured to, in response to selecting the variable model as the champion model, store the variable model selected as the champion model as the optimal model in the optimal model storage place in a FIFO manner.

5. The device of claim 1, further comprising
a model management part configured to decide whether there is a insufficiency of a storage space of the optimal model storage place, and
the model management part is further configured to, in response to selecting the variable model as the champion model and deciding insufficiency of a storage space of the optimal model storage place, delete the existing optimal model in chronological order of storage according to a FIFO manner and store the variable model selected as the champion model as the optimal model in the optimal model storage place in a FIFO manner.

6. The device of claim 1, further comprising
a model management part configured to, in response to selecting the existing optimal model as the champion model, extract the existing optimal model selected as the champion model from the optimal model storage place and store the existing optimal model again in the optimal model storage place in a FIFO manner.

7. The device of claim 1, further comprising
a model management part configured to, in response to selecting the seed model as the champion model, maintain a state in which the seed model selected as the champion model is stored in the seed model storage place.

8. The device of claim 1, wherein the model generation part is configured to generate the variable model through training with the training data created from raw data collected within a predetermined period of time from a time point of generation, the variable model being based on design information of the seed model.

9. A device for selecting an optimal model, the device comprising:
a model evaluation part configured to, in response to generation of a variable model, use evaluation data to select a champion model from a plurality of evaluation target models including the generated variable model, a seed model stored in a seed model storage place, and an existing optimal model stored in an optimal model storage place by evaluating the plurality of evaluation target models; and
a model management part configured to store the champion model in the optimal model storage place.

10. The device of claim 9, wherein the model evaluation part is configured to
receive training data created from raw data received within a predetermined period of time from a time point of evaluation,
detect, from the received training data, input data and output data related to the input data,
set the output data as an expected value, and
set the input data and the expected value as the evaluation data.

11. The device of claim 10, wherein the model evaluation part is configured to
input the input data to each of the plurality of evaluation target models, and
in response to performing operation on the input data by each of the plurality of evaluation target models to calculate a prediction value,
calculate a difference between the expected value and the prediction value of each of the plurality of evaluation target models as an error of each of the plurality of evaluation target models, and
select the evaluation target model having the smallest error among the plurality of evaluation target models as the champion model.

12. The device of claim 9, wherein the model management part is configured to decide whether there is a insufficiency of a storage space of the optimal model storage place, and
the model management part is further configured to, in response to selecting the variable model as the champion model and deciding insufficiency of a storage space of the optimal model storage place, delete the existing optimal model in chronological order of storage according to a FIFO manner and
store the variable model selected as the champion model as the optimal model in the optimal model storage place in a FIFO manner.

13. The device of claim 9, wherein the model management part is configured to, in response to selecting the existing optimal model as the champion model, extract the existing optimal model selected as the champion model from the optimal model storage place and store the existing optimal model again in the optimal model storage place in a FIFO manner.

14. The device of claim 9, further comprising
a model generation part configured to generate the variable model through training with training data created from raw data collected within a predetermined period of time from a time point of generation, the variable model being based on design information of the seed model.

15. A method for selecting an optimal model, the method comprising:
maintaining a state in which a seed model is stored in a seed model storage place and an existing optimal model is stored in an optimal model storage place;
using, by a model generation part, training data to generate a variable model;
preparing evaluation data by a model evaluation part; and
using, by the model evaluation part, the evaluation data to select a champion model from among a plurality of evaluation target models including the seed model, the existing optimal model, and the variable model by evaluating the plurality of evaluation target models.

16. The method of claim 15, wherein the preparing of the evaluation data comprises:
receiving, by the model evaluation part, the training data created from raw data received within a predetermined period of time from a time point of evaluation;
detecting, by the model evaluation part, input data and output data related to the input data from the received training data;
setting, by the model evaluation part, the output data as an expected value; and
setting, by the model evaluation part, the input data and the expected value as the evaluation data.

17. The method of claim 16, wherein the selecting of the champion model comprises:
inputting, by the model evaluation part, the input data to each of the plurality of evaluation target models;
performing, by each of the plurality of evaluation target models, operation on the input data to calculate a prediction value;
calculating, by the model evaluation part, a difference between the expected value and the prediction value of each of the plurality of evaluation target models as an error of each of the plurality of evaluation target models; and
selecting, by the model evaluation part, the evaluation target model having the smallest error among the plurality of evaluation target models as the champion model.

18. The method of claim 15, further comprising
storing, by a model management part in response to selecting the variable model as the champion model, the variable model selected as the champion model in the optimal model storage place in a FIFO manner.

19. The method of claim 15, further comprising,
deciding whether there is an insufficiency of a storage space of the optimal model storage place,
in response to selecting the variable model as the champion model and deciding insufficiency of a storage space of the optimal model storage place,
deleting, by a model management part, the existing optimal model in chronological order of storage according to a FIFO manner, and storing the variable model selected as the champion model in the optimal model storage place in a FIFO manner.

20. The method of claim 15, further comprising
extracting, by a model management part in response to selecting the existing optimal model as the champion model, the existing optimal model selected as the champion model from the optimal model storage place and storing the existing optimal model again in the optimal model storage place in a FIFO manner.
